(19) United States
(12) Patent Application Publication
(10) Pub. No.: US 2025/0270078 A1
(43) Pub. Date: Aug. 28, 2025

(54) SENSOR DEVICE, FORKLIFT, AND CONTROL METHOD FOR SENSOR DEVICE

(71) Applicant: Wuhu Lingdong Acceleration Robotics Technology Co., Ltd., Wuhu (CN)

(72) Inventors: Ou QI, Wuhu (CN); Hao SHEN, Wuhu (CN); Yanzhuo FAN, Wuhu (CN); Tianjie DAI, Wuhu (CN); Yuchen ZHAO, Wuhu (CN); Jin CHENG, Wuhu (CN)

(21) Appl. No.: 19/062,960

(22) Filed: Feb. 25, 2025

(30) Foreign Application Priority Data
Feb. 27, 2024 (CN) 2024102184198

(51) Int. Cl. B66F 9/075; G01S 13/86; G01S 13/931

(52) U.S. Cl. CPC B66F 9/0755; G01S 13/867; G01S 13/931; G01S 2013/93273

(57) ABSTRACT

The present application relates to a sensor device, a forklift, and a control method for the sensor device. The sensor device comprises: a support structure comprising a support plate, pillars, and a fixing member, one end of each pillar being connected to the support plate and the other end being connected to the fixing member; a first radar disposed on the support plate and located between the support plate and the fixing member; and cameras disposed on the support plate and located between the support plate and the fixing member. The sensor device in this application integrates radars and cameras, facilitating cable routing for both radars and cameras, thereby improving production efficiency.

### TECHNICAL FIELD

The present application relates to the field of sensors, in particular to a sensor device, a forklift, and a control method for the sensor device.

### BACKGROUND

Intelligent forklifts have been used in warehouses for cargo handling to replace manual forklifts, reducing labor costs. Compared to AGVs (Automated Guided Vehicles) or AMRs (Autonomous Mobile Robots), intelligent forklifts can directly move pallets and their contents across a flat surface without the need for additional lifting mechanisms or docking devices.

Intelligent forklifts are typically equipped with laser radars and cameras for sensing the external environment. The laser radar is generally mounted on the top of the intelligent forklift, and the camera is usually mounted on the middle to lower part of the side wall of the intelligent forklift, creating a considerable distance between them that complicates cable routing.

### SUMMARY

Based on the above problems, the present application provides a sensor device, a forklift, and a control method for the sensor device. The sensor device integrates radars and cameras, making cable routing easier.

In a first aspect, an embodiment of the present application provides a sensor device, comprising:
a support structure comprising a support plate, pillars, and a fixing member, an end of each pillar being connected to the support plate and another end of each pillar being connected to the fixing member;
a first radar disposed on the support plate and located between the support plate and the fixing member; and
cameras disposed on the support plate and located between the support plate and the fixing member.

According to some embodiments of the present application, a centerline of the first radar is inclined relative to a vertical direction, and the cameras are tilted downward.

According to some embodiments of the present application, the centerline of the first radar coincides with a vertical central plane of at least one of the pillars.

According to some embodiments of the present application, a number of the pillars is at least three.

According to some embodiments of the present application, a number of the cameras is at least three, with one of the cameras disposed between each two adjacent pillars.

According to some embodiments of the present application, the sensor device further comprises:
a first cushion block disposed on the support plate, the first radar being disposed on the first cushion block; and
camera holders disposed on the support plate, the cameras being disposed on the camera holders.

According to some embodiments of the present application, the sensor device further comprises a second radar disposed on a side, away from the fixing member, of the support plate.

According to some embodiments of the present application, the sensor device further comprises a leveling mechanism, and the leveling mechanism comprises:
a leveling plate, the second radar being disposed on the leveling plate, the leveling plate being securely connected to the side, away from the fixing member, of the support plate, and the leveling plate featuring leveling threaded holes; and
leveling screws compatible with the leveling threaded holes and abutting against the support plate.

According to some embodiments of the present application, the sensor device further comprises:
an indicator light connected to the support plate; and/or
a projector disposed on the fixing member.

According to some embodiments of the present application, the cameras and the first radar have internal and external calibrated parameters and are time synchronized with each other.

According to some embodiments of the present application, the cameras, the first radar and the second radar have internal and external calibrated parameters and are time synchronized with each other.

In a second aspect, an embodiment of the present application provides a forklift, comprising:
a forklift body; and
the sensor device as described above disposed on a top of the forklift body.

According to some embodiments of the present application, a vertical central plane of at least one of the pillars coincides with a vertical central plane of the forklift body.

In a third aspect, an embodiment of the present application provides a method for controlling a sensor device, comprising:
confirming whether an obstacle is detected based on signals from a first radar and cameras; and
if an obstacle is confirmed to be detected, analyzing a type of the obstacle, determining a lighting color of an indicator light on a side corresponding to the obstacle based on the type of the obstacle, and controlling the indicator light on the side corresponding to the obstacle to illuminate.

According to some embodiments of the present application, the method further comprise:
calibrating internal and external parameters of the cameras and the first radar, and synchronizing time of the cameras and the first radar.

In this application, both the first radar and the cameras are disposed between the support plate and the fixing member, and the sensor device integrates radars and cameras, facilitating cable routing for both radars and cameras, thereby improving production efficiency.

### BRIEF DESCRIPTION OF THE DRAWINGS

In order to explain the technical scheme of the application more clearly, the drawings used in the description of the embodiments will be briefly introduced below. Obviously, the drawings in the following description are only some embodiments of the application. For those of ordinary skill in the art, other drawings can be obtained from these drawings without exceeding the protection scope of this application.

FIG. 1 is a schematic diagram of a sensor device according to an embodiment of the application;

FIG. 2 is a schematic diagram of a first radar arranged in an inclined manner according to an embodiment of the application;

FIG. 3 is a schematic diagram of the field of view of a first radar according to an embodiment of the application;

FIG. 4 is a schematic diagram showing a centerline of a first radar coinciding with a vertical central plane of a first pillar according to an embodiment of the application;

FIG. 5 is a schematic diagram of a pillar according to an embodiment of the application;

FIG. 6 is a schematic diagram of a first cushion block and a camera holder according to an embodiment of the application;

FIG. 7 is a schematic diagram of a second radar according to an embodiment of the application;

FIG. 8 is a partially enlarged view of a leveling mechanism according to an embodiment of the application;

FIG. 9 is a schematic diagram of connecting holes of a leveling mechanism according to an embodiment of the application;

FIG. 10 is a schematic diagram of an indicator light and a projector according to an embodiment of the application;

FIG. 11 is a schematic diagram of a forklift according to an embodiment of the application; and

FIG. 12 is a top view of the field of view of a first radar according to an embodiment of the application.

### DETAILED DESCRIPTION OF EMBODIMENTS

The technical scheme of the application will be described clearly and completely with reference to the drawings in the embodiments of the application. Obviously, the described embodiments are part of the embodiments of the application, not all of them. All other embodiments obtained by those of ordinary skill in the art based on the embodiments in this application without creative labor fall within the protection scope of this application.

As shown in FIG. 1, an embodiment of the present application provides a sensor device 100, which comprises a support structure 1, a first radar 2, and cameras 3. The support structure 1 provides support for the first radar 2 and the cameras 3, and the sensor device 100 integrates radars and cameras.

The support structure 1 consists of a support plate 11, pillars 12, and a fixing member 13. One end of the pillar 12 is connected to the support plate 11, and the other end of the pillar 12 is connected to the fixing member 13. A receiving space is formed between the support plate 11 and the fixing member 13. The fixing member 13 is used to connect to a smart mobile device, for example, the fixing member 13 is connected to a forklift body, and the pillars 12 support the support plate 11.

The first radar 2 is disposed beneath the support plate 11, within the receiving space between the support plate 11 and the fixing member 13. Optionally, the first radar 2 is a multi-line laser radar.

The cameras 3 are also placed beneath the support plate 11, within the receiving space between the support plate 11 and the fixing member 13. Optionally, in a vertical direction, the camera 3 is located above the first radar 2 to prevent the first radar 2 from affecting the field of view of the camera 3 or the camera 3 from impacting the field of view of the first radar 2.

The sensor device 100 is disposed on a smart mobile device, such as being mounted on an intelligent forklift. The sensor device 100 communicates with a controller of the smart mobile device, with signals from both the first radar 2 and the cameras 3 being transmitted to the controller. The controller achieves obstacle perception based on the signals from the first radar 2 and the cameras 3. The controller may process the signals from the first radar 2 and the cameras 3 by means of existing methods.

The sensor device 100 integrates radars and cameras, allowing the bundling of power cables and signal transmission cables for both the radars and cameras into a single cable harness. This facilitates wiring on smart mobile devices and enables 360° panoramic safety perception for the smart mobile devices.

In traditional intelligent forklifts, a centerline of a radar is oriented vertically. Taking the side where fork arms of the forklift are located as the front side of the forklift, the field of view of the radar has the same height in the forward and backward directions of the forklift. The fork arms of the forklift move up and down when handling goods, necessitating a great height for the forward field of view. The existing radar configurations fail to meet the application needs of forklifts during material handling, leading to a risk of collisions.

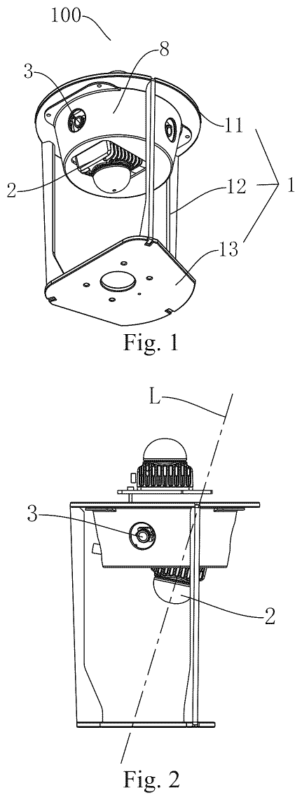

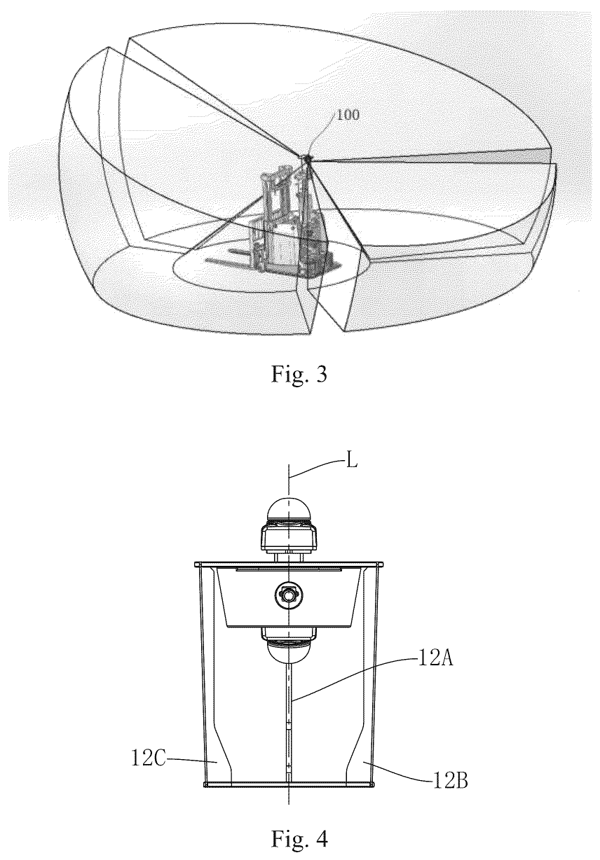

As shown in FIGS. 2 and 3, in some embodiments, a centerline L of the first radar 2 is inclined relative to the vertical direction, giving the first radar 2 an inclined field of view. When the sensor device 100 is installed on an intelligent forklift, the side of the first radar 2 with a higher field of view corresponds to the front side of the forklift, resulting in a field of view that is higher in the front and lower in the back, thus meeting the needs of the intelligent forklift for material handling. The angle of inclination of the centerline L of the first radar 2 is set according to requirements.

The camera 3 is inclined downward to detect objects that are lower than the camera 3, allowing the forklift to position itself or avoid obstacles based on the perceived information. The angle of inclination of the camera 3 may be adjusted according to requirements.

As shown in FIG. 4, in some embodiments, the centerline L of the first radar 2 coincides with a vertical central plane of at least one of the pillars 12. For example, the centerline L of the first radar 2 coincides with a vertical central plane of a first pillar 12A. The pillar 12 affects the field of view of the first radar 2, creating blind spots in the field of view of the first radar 2. By aligning the centerline L of the first radar 2 with the vertical central plane of at least one pillar 12, a symmetrical field of view area is created for the first radar 2, which is beneficial for detecting obstacles.

In some embodiments, a number of the pillars 12 is at least three. For example, the three pillars 12 are designated as a first pillar 12A, a second pillar 12B, and a third pillar 12C, which are evenly distributed around a vertical axis to provide stable support for the support plate 11. This arrangement helps prevent unnecessary shaking of the first radar 2 and the cameras 3 during the movement of the smart mobile device.

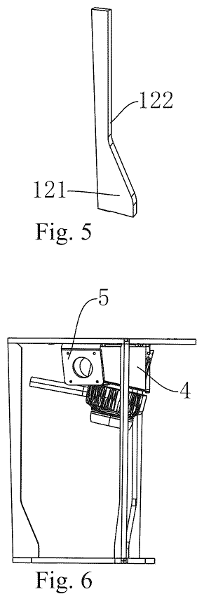

As shown in FIG. 5, optionally, the pillar 12 is plate-like and features a wide side wall 121 and a narrow side wall 122. The narrow side wall 122 of the pillar 12 faces the first radar 2 to minimize the impact of the pillar 12 on the field of view of the first radar 2.

In one implementation mode, a fixing member 13 is correspondingly disposed below each pillar 12, with multiple fixing members 13 connected to the smart mobile device. In another implementation mode, multiple pillars 12 are connected to the same fixing member 13.

In some embodiments, a number of the cameras 3 is at least three, with one camera 3 disposed between each two adjacent pillars 12, maintaining equal distances from the camera 3 to the two neighboring pillars 12. The presence of multiple cameras 3 enhances the perception capability of the forklift.

As shown in FIG. 6, in some embodiments, the sensor device 100 also comprises a first cushion block 4 and camera holders 5, both of which are disposed on a lower surface of the support plate 11. The first radar 2 is disposed on a bottom surface of the first cushion block 4, and the bottom surface of the first cushion block 4 is inclined to meet the tilting requirements of the first radar 2. The cameras 3 are mounted on the camera holders 5, with each camera holder 5 corresponding to one camera 3.

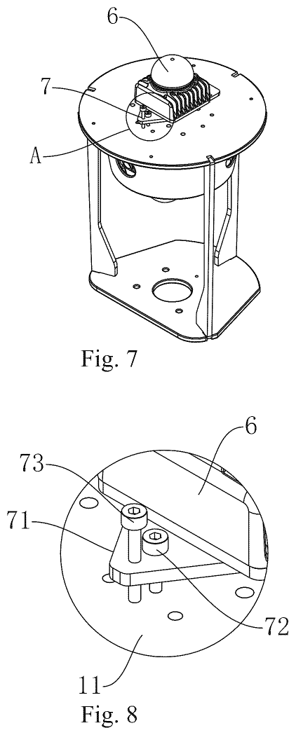

As shown in FIG. 7, in some embodiments, the sensor device 100 further comprises a second radar 6, which is installed on a side, away from the fixing member 13, of the support plate 11. Optionally, the second radar 6 is a multi-line laser radar. A centerline of the second radar 6 is oriented vertically to assist in the positioning of the smart mobile device.

Optionally, the cameras 3, the first radar 2 and/or the second radar 6 can have internal and external calibrated parameters, and have been time synchronized with each other, enabling registration of the point cloud and image pixel and enabling 360° observation of the surrounding environment without any blind area, and thus enabling obstacle detection for pedestrian, vehicle and other objects can be achieved based on the observation of the point cloud and color value. The specific calibration methods for internal and external parameters can be carried out based on existing methods.

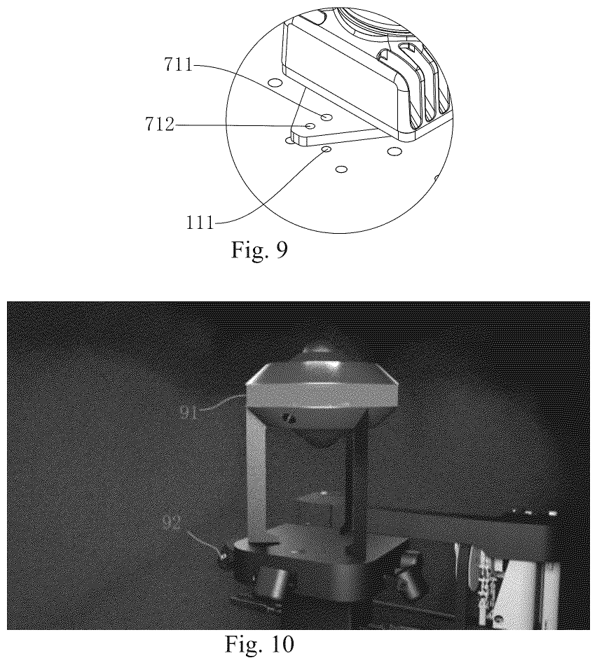

As shown in FIGS. 8 and 9, in some embodiments, the sensor device 100 also comprises a leveling mechanism 7. The leveling mechanism 7 comprises a leveling plate 71 and leveling screws 73. The leveling plate 71 is disposed on a surface, away from a second connecting plate 13, of the support plate 11, and the second radar 6 is mounted on the leveling plate 71. The leveling plate 71 is securely connected to the support plate 11. For example, the leveling plate 71 is provided with through holes 711, and the support plate 11 is equipped with threaded holes 111. Screws 72 pass through the through holes 711 and connect with the threaded holes 111 to fasten the leveling plate 71 to the support plate 11. Additionally, the leveling plate 71 is provided with leveling threaded holes 712 which are compatible with the leveling screws 73. A bottom end of the leveling screw 73 can rest against the support plate 11. Multiple leveling screws 73 are arranged along an edge of the leveling plate 71, and by rotating the leveling screws 73, a top surface of the leveling plate 71 can be adjusted to be level, which helps improve the positioning accuracy of the second radar 6.

During installation, the leveling screws 73 are first adjusted to ensure that the top surface of the leveling plate 71 is level, and then the screws 72 are tightened to secure the leveling plate 71 in place.

Optionally, the sensor device 100 also comprises a cover 8 which is disposed on a bottom surface of the support plate 11, with the first cushion block 4 and the camera holders 5 located within the cover 8. The cover 8 is equipped with through holes compatible with the first radar 2 and the cameras 3 to prevent the cover 8 from obstructing the fields of view of the first radar 2 and the cameras 3.

As shown in FIG. 10, the sensor device 100 also comprises an indicator light 91 and/or a projector 92. The indicator light 91 is connected to the support plate 11. Optionally, the indicator light 91 comprises an LED light strip, which is arranged in a circular manner on an outer wall of the cover 8. The LED light strip can emit light in different colors. The indicator light 91 is connected to the controller of the smart mobile device.

The signals from the first radar 2 and the cameras 3 are sent to the controller of the smart mobile device. The controller determines whether an obstacle is detected based on the signals from the first radar 2 and the cameras 3.

If an obstacle is confirmed to be detected, the controller analyzes a type of the obstacle, determines a lighting color of an indicator light on the side of the obstacle based on the type of the obstacle, and controls the indicator light on the side of the obstacle to illuminate.

For example, when the obstacle detected is a pedestrian, the LED light strip emits red light; and when the obstacle detected is a vehicle, the LED light strip emits green light. The controller can control the section of the LED light strip on the side where the obstacle is located to light up, while the rest of the LED light strip remains off, signaling to pedestrians or vehicles that they have been detected by the smart mobile device.

The projector 92 is disposed on the fixing member 13. For example, multiple projectors 92 are disposed on a side wall of the fixing member 13. The projector 92 is connected to the controller of the smart mobile device. The projector 92 can project the analysis results of obstacles from the controller onto the ground. For example, the projector 92 may display text identifying the detected obstacle as either a pedestrian or a vehicle. Additionally, the projector 92 can project the actions of the smart mobile device onto the ground, such as arrows indicating straight movement or turns.

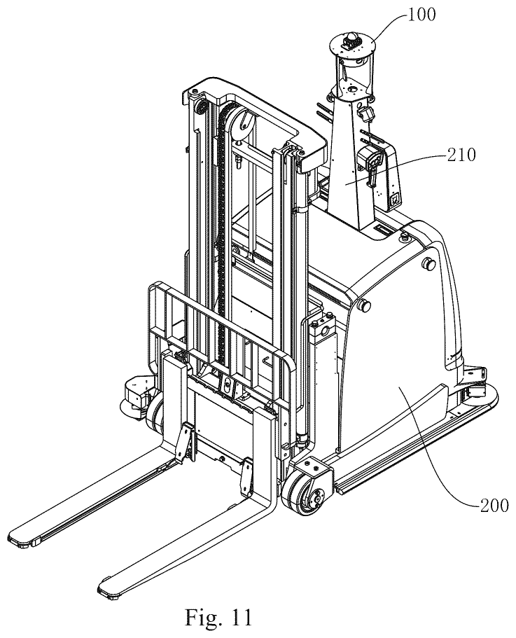

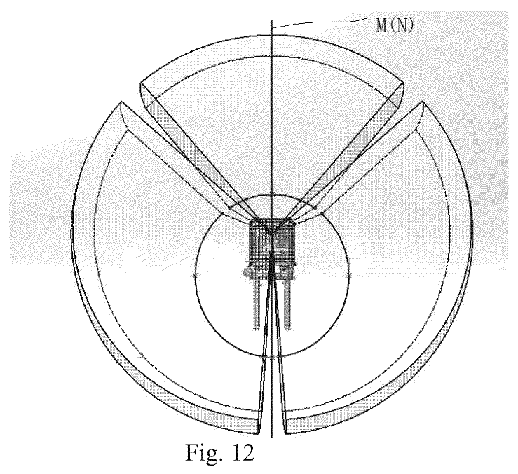

As shown in FIG. 11, an embodiment of the present application provides a forklift, which comprises a forklift body 200 and the sensor device 100 as described above. The forklift body 200 is an existing intelligent forklift. A top of the forklift body 200 is equipped with a sensor support member 210, and the sensor device 100 is mounted at a top end of the sensor support member 210. The fixing member 13 is securely connected to the sensor support member 210. The radars and cameras of the sensor device 100 both communicate with a controller of the forklift body 200 for environmental perception.

As shown in FIG. 12, a vertical central plane of at least one of the pillars coincides with a vertical central plane of the forklift body. For example, the vertical central plane M of the first pillar 12A coincides with the vertical central plane N of the forklift body 200, making the field of view of the first radar 2 bilaterally symmetrical relative to the forklift body 200, which helps enhance the perception capability of the forklift.

An embodiment of the present application provides a method for controlling a sensor device 100, and the sensor device 100 further comprises an indicator light 91. The indicator light 91 is connected to the support plate 11. Optionally, the indicator light 91 comprises an LED light strip, which is arranged in a circular manner on an outer wall of the cover 8. The LED light strip can emit light in different colors. The indicator light 91 is connected to the controller of the smart mobile device. The control method comprises the following steps:

S1, confirming whether an obstacle is detected based on signals from a first radar and cameras.

The signals from the first radar 2 and the cameras 3 being sent to the controller of the smart mobile device, and the controller determining whether an obstacle is detected based on the signals from the first radar 2 and the cameras 3.

S2, if an obstacle is confirmed to be detected, analyzing a type of the obstacle, determining a lighting color of an indicator light on a side corresponding to the obstacle based on the type of the obstacle, and controlling the indicator light on the side corresponding to the obstacle to illuminate.

For example, when the obstacle detected is a pedestrian, the LED light strip emits red light; and when the obstacle detected is a vehicle, the LED light strip emits green light. The controller can control the section of the LED light strip on the side where the obstacle is located to light up, while the rest of the LED light strip remains off, signaling to pedestrians or vehicles that they have been detected by the smart mobile device.

Taking an intelligent forklift as an example, if a manually controlled regular forklift is driving towards it, and the controller of the intelligent forklift analyzes the type of obstacle based on the signals from the first radar 2 and the cameras 3 as a pedestrian, the LED light strip will emit red light. An operator controlling the regular forklift will see the red light from the LED light strip of the intelligent forklift and realize that the type of obstacle analyzed by the intelligent forklift is incorrect, and then maneuver the regular forklift to avoid the intelligent forklift. If the controller of the intelligent forklift analyzes the type of obstacle based on the signals from the first radar 2 and the cameras 3 as a vehicle, the LED light strip will emit green light. Upon seeing the green light from the LED light strip of the intelligent forklift, the operator of the regular forklift will know that the intelligent forklift has detected the regular forklift.

Optionally, before step S1, the control method further comprises step S0: calibrating the internal and external parameters of the cameras and the first radar, and synchronizing time of the cameras and the first radar.

That is, calibration of the internal and external parameters and time synchronization are performed on the cameras and radar before step S1. This ensures that the sensor device 100 can observe the surrounding environment 360° without any blind area.

By performing internal and external parameter calibration and time synchronization on the cameras and radar, registration of the point cloud and image pixel and 360° observation of the surrounding environment without any blind area can be achieved, thus enabling obstacle detection for pedestrian, vehicle and other objects based on the observation of the point cloud and color value. The specific calibration methods for internal and external parameters can be carried out based on existing methods.

The embodiments of the application have been introduced in detail above. Specific examples are applied herein to illustrate the principle and implementation of the application. The above embodiments are only used to help understand the technical scheme of the application and its core ideas. The changes or deformations made by those skilled in the art based on the ideas of the application and the specific implementation and application scope of the application are within the scope of protection of the application. To sum up, the content of this specification should not be construed as a limitation of the application.

What is claimed is:

1. A sensor device, comprising:
a support structure comprising a support plate, pillars, and a fixing member, an end of each pillar being connected to the support plate and another end of each pillar being connected to the fixing member;
a first radar disposed on the support plate and located between the support plate and the fixing member; and
cameras disposed on the support plate and located between the support plate and the fixing member.

2. The sensor device according to claim 1, wherein a centerline of the first radar is inclined relative to a vertical direction, and the cameras are tilted downward.

3. The sensor device according to claim 2, wherein the centerline of the first radar coincides with a vertical central plane of at least one of the pillars.

4. The sensor device according to claim 1, wherein a number of the pillars is at least three.

5. The sensor device according to claim 4, wherein a number of the cameras is at least three, with one of the cameras disposed between each two adjacent pillars.

6. The sensor device according to claim 1, further comprising:
a first cushion block disposed on the support plate, the first radar being disposed on the first cushion block; and
camera holders disposed on the support plate, the cameras being disposed on the camera holders.

7. The sensor device according to claim 1, further comprising a second radar disposed on a side, away from the fixing member, of the support plate.

8. The sensor device according to claim 1, further comprising:
an indicator light connected to the support plate; and/or
a projector disposed on the fixing member.

9. The sensor device according to claim 1, wherein the cameras and the first radar have internal and external calibrated parameters and are time synchronized with each other.

10. The sensor device according to claim 7, wherein the cameras, the first radar and the second radar have internal and external calibrated parameters and are time synchronized with each other.

11. A forklift, comprising:
a forklift body; and
the sensor device according to claim 1 disposed on a top of the forklift body.

12. The forklift according to claim 11, wherein a centerline of the first radar is inclined relative to a vertical direction, and the cameras are tilted downward.

13. The forklift according to claim 12, wherein the centerline of the first radar coincides with a vertical central plane of at least one of the pillars.

14. The forklift according to claim 11, wherein a number of the pillars is at least three.

15. The forklift according to claim 14, wherein a number of the cameras is at least three, with one of the cameras disposed between each two adjacent pillars.

16. The forklift according to claim 11, wherein the sensor device further comprises:
a first cushion block disposed on the support plate, the first radar being disposed on the first cushion block; and
camera holders disposed on the support plate, the cameras being disposed on the camera holders.

17. The forklift according to claim 11, wherein the sensor device further comprises a second radar disposed on a side, away from the fixing member, of the support plate.

18. The forklift according to claim 11, wherein the sensor device further comprises:
an indicator light connected to the support plate; and/or
a projector disposed on the fixing member.

19. A method for controlling a sensor device, comprising:
confirming whether an obstacle is detected based on signals from a first radar and cameras; and
if an obstacle is confirmed to be detected, analyzing a type of the obstacle, determining a lighting color of an indicator light on a side corresponding to the obstacle based on the type of the obstacle, and controlling the indicator light on the side corresponding to the obstacle to illuminate.

20. The method according to claim 19, further comprising:
calibrating internal and external parameters of the cameras and the first radar, and synchronizing time of the cameras and the first radar.
